(19) United States
(12) Patent Application Publication
(10) Pub. No.: US 2014/0261313 A1
(43) Pub. Date: Sep. 18, 2014

(54) FUEL INJECTION SYSTEM FOR INTERNAL COMBUSTION ENGINE

(71) Applicant: Brian Provost, Loreauville, LA (US)

(72) Inventor: Brian Provost, Loreauville, LA (US)

(21) Appl. No.: 14/212,375

(22) Filed: Mar. 14, 2014

Related U.S. Application Data
(60) Provisional application No. 61/801,265, filed on Mar. 15, 2013.

(51) Int. Cl. F02M 61/16

(52) U.S. Cl. CPC F02M 61/168
USPC 123/344; 123/446

(57) ABSTRACT

A kit for replacing a carburetor-based fuel delivery system for internal combustion engines with an electronic fuel injection system has an electronic control unit receiving signals from pressurization pump and a number of sensors mounted on the throttle, engine and the manifold. According to the invention, the standard manifold is replaced with the machined manifold which carries at least one fuel injector with a nozzle that can extend into an intake chamber of the engine. A pressure regulator maintains the fuel in the fuel lines at a set value and re-circulates unused fuel through a fuel reservoir/vapor separator.

### CROSS-REFERENCE TO RELATED APPLICATIONS

This application is a nonprovisional application based on my provisional patent application Ser. No. 61/801,265, filed on Mar. 15, 2013 and entitled “Electronic fuel injection system and including a kit for conversion from carburetor to injection system,” the full disclosure of which is incorporated by reference herein and priority of which is hereby claimed.

### BACKGROUND OF THE INVENTION

The present invention relates generally to internal combustion engines and to methods and arrangements for controlling internal combustion engines to operate more efficiently. More particularly, this invention is directed to a system, which replaces the carburetor system on a small displacement engine with a modern electronic fuel injection system.

The carburetor and fuel injection performance largely depends on the amount of air and gasoline that can enter into the cylinders of an internal combustion engine. The cylinders contain the pistons and combustion chambers where energy is released from the combustion of gasoline. Both carburetor-based fuel supply systems and electronic fuel injection systems feed fuel and air into the engine. In carburetor-based systems, jet conduits force the gas into the combustion chambers. The amount of fuel that can flow through these jets depends completely on the amount of air that can be pulled into the carburetor. In the carburetor-based system it becomes impossible to monitor the air to fuel ratio for each individual cylinder. Some of the common problems associated with a carburetor-based system are hard starting, poor idling, and stalling.

To improve engine performance, many manufacturers abandon carburetor-based systems in favor of electronic fuel injection systems (EFI). In direct injection EFI systems the amount of fuel and air can be perfectly released and then injected into the cylinder according to the engine load conditions. The EFI systems allow controlled fuel injection resulting in a higher power output, greater fuel efficiency and much lower emissions.

The present invention contemplates provision of a system for retrofitting a standard carburetor-based fuel supply system with a fuel injection system.

### SUMMARY OF THE INVENTION

It is, therefore, an object of the present invention to provide a system for replacing a carburetor-based fuel supply system of an internal combustion engine with an electronic fuel injection system.

It is another object of the invention to replace a carburetor-based fuel supply system of an internal combustion engine with an electronic fuel injection system that is easy to install and operate.

These and other objects of the invention are achieved through a provision of A kit for replacing a carburetor-based fuel delivery system for internal combustion engines with an electronic fuel injection system has an electronic control unit receiving signals from pressurization pump and a number of sensors mounted on the throttle, engine and the manifold. According to the invention, the standard manifold is replaced with the machined manifold which carries at least one fuel injector with a nozzle that can extend into an intake chamber of the engine. A pressure regulator maintains the fuel in the fuel lines at a set value and re-circulates unused fuel through a fuel reservoir/vapor separator. The system of this invention uses two pumps: a low pressure pump connected to a fuel tank and a high-pressure pump mounted upstream from the fuel reservoir/vapor separator. The system can be used in applications requiring smaller displacement engines, for instance on generators, riding lawnmowers, and shallow water outboard motors. The instant system improves fuel efficiency and lowers emissions.

### BRIEF DESCRIPTION OF THE DRAWINGS

Reference will now be made to the drawings, wherein like parts are designated by like numerals, and wherein

FIG. 1 is a schematic view of the fuel injection system according to the present invention.

FIG. 2 is a detail, partially cutaway view illustrating a portion of an intake manifold from throttle body side.

FIG. 3 is a detail view illustrating the intake manifold and an intake throttle.

FIG. 4 is a schematic view illustrating injection of pressurized fuel into the intake manifold.

### DETAIL DESCRIPTION OF THE INVENTION

Turning now to the drawings in more detail, numeral 10 designates the fuel injection system according to the present invention. The system 10 comprises a low-pressure feed pump 12 which sucks fuel from a fuel tank 14, a vapor separator 16 mounted downstream from the feed pump 12, a high-pressure pump 18 connected to the vapor separator 16, one or more fuel injectors 20, 22, a fuel regulator 24, and an electronic control unit (ECU) 26 operationally connected to the high-pressure pump 18 and the fuel injectors 20, 22. The feed pump 12 is operationally connected to the high-pressure pump 18, as schematically shown in FIG. 1.

The system 10 also includes an engine temperature sensor 28 and an intake air temperature sensor 30, with both sensors operationally connected to the electronic control unit via suitable wiring 32 and 34, respectively. A manifold absolute pressure sensor (MAP sensor) 36 is mounted on a manifold 38; the MAP sensor 36 is similarly connected to the ECU 26 by suitable wiring 40. The fuel injectors 20 and 22 are each electronically connected to the ECU 26 by wiring 42 and 46, respectively. The manifold 38 spans between engine cylinders 76, 78, such that the injector 2—is aligned with the cylinder 76, while the injector 22 is aligned with the engine cylinder 78.

The modified intake manifold 38 replaces the intake manifold of a carburetor-based system. In the manifold 38, the restrictive bridge at the carburetor mounting area has been removed allowing more air to flow into the engine. The intake manifold is also fabricated and machined to accept fuel injectors 20, 22 that direct the flow of air-fuel mixture toward open intake valve 102 into the combustion chamber 112.

The fuel tank 14 contains liquid fuel compatible with the operation of an internal combustion engine 50. A fuel filter 48 is mounted between the fuel tank 14 and the feed pump 12. The fuel filter 48 is configured to screen out dirt, paint and rust particles from the fuel, and other foreign material that can potentially damage the engine fuel system 10 by abrasion. The fuel filter 48 also improves performance of the engine 50 by delivering contaminant-free fuel to the engine. Cleaner fuel results in more efficient burning of the liquid fuel. In one aspect of the invention, the fuel filter 48 is formed as a replaceable cartridge.

The liquid fuel is pumped from the fuel tank 14 through the fuel filter 48 by the low-pressure feed pump 12. In one aspect of the invention the feed pump 12 can operate at about 3 PSI. The outlet 52 of the feed pump 12 is connected to the fuel vapor separator 16, which separates the fuel sent from the fuel tank 14 by the low-pressure feed pump 12 into gas and liquid to release fuel vapor to an atmosphere. The vapor separator 16 comprises a hollow separator body 54 having a bottom outlet 56 and a top vapor outlet 58. A fuel return line 60 is fluidly connected to the separator body 54 via a return inlet 62 coupled to the body 54 of the vapor separator 16.

A float valve 64 is positioned in the body 54 of the vapor separator 16 and is configured to float on the surface of the liquid fuel pumped into the body 54. The float valve 64 is supported by a hinge plate 68 secured to an inner wall of the body 54. A shoulder 70 is formed in the body 54 above the float valve 64 to limit an upward movement of the float valve 64. The hinge plate 68 carries a needle valve 72, which is aligned with the vapor outlet 58 to close the vapor outlet 58, as will be described in more detail hereinafter.

The outlet 56 of the vapor separator 16 feeds into the high-pressure pump 18, which is designed to maintain about 40 PSI pressure on a fuel line 74 connecting the high-pressure pump 18 with the fuel pressure regulator 24 and ultimately with the fuel injectors 20, 22, which are positioned on the manifold 38. Although a two-cylinder engine 50 is illustrated in the drawings, it is envisioned that the system of the present invention can be used with other types of engines. The manifold 38 is used to divide the fuel supply into the required number of cylinders. The injector 20 injects fluid into engine cylinder 76, while the injector 22 injects fuel into engine cylinder 78.

Fuel injection atomizes the fuel by forcibly pumping it through a small nozzle under high pressure created by the high-pressure pump 18 so that the fuel can burn easily. When the injectors 20, 22 are energized, an electromagnet (not shown) moves a plunger that opens the valve, allowing the pressurized fuel to squirt out through a small nozzle. The amount of fuel supplied to the engine 50 is determined by the amount of time the fuel injectors 20, 22 stay open. The ECU 26 controls the timing. The injectors 20, 22 are mounted in the intake manifold 38 so that they spray fuel directly at the intake valves of the engine 50.

Maintaining the correct fuel pressure is done by the fuel pressure regulator 24. The fuel injectors 20, 22 inject liquid fuel directly into the engine cylinders, where the fuel is mixed with air supplied by a throttle device 80 mounted on the manifold 38 between the injectors 20, 22. When the user steps on the gas pedal, the throttle valve opens up more, letting in more air. The ECU 26 detects opening of the throttle valve and increases the fuel rate in anticipation of more air entering the engine.

The sensors 30 and 36 monitor the temperature of intake air as well as pressure in the manifold 38. The ECU 26 uses this information to fine-tune the fuel delivery into the engine 50. The MAP sensor 36 detects air pressure in the manifold 38 and instantaneously transmits the detected value to the ECU 26. The data is used to calculate air density and determine the engine's air mass flow rate, which in turn determines the required fuel metering for optimum combustion and influence the advance or retard of ignition timing. Generally, the amount of air being drawn into the engine 50 is a good indication of how much power the engine is producing; and the more air that goes into the engine, the lower the manifold pressure, so the reading of the MAP sensor 36 is used to gauge how much power is being produced.

The fuel injectors 20, 22 are not energized at all time during the engine operation. Excess fuel from the high-pressure pump 18 is routed to the pressure regulator 24, which keeps upstream pressure at 40 psi and downstream at 1 ATM. An outlet 82 of the regulator 24 is fluidly connected to the fuel return line 60 and this to the return inlet 62 of the vapor separator 16. Excess fuel is delivered by gravity into the lower part of the body, where it is mixed with the fuel delivered from the fuel tank 14. The mixed fuel from the separator 16 is re-circulated through the system 10. The vapor, which rises to the top of the separator body 54, is routed to the throttle device 80, where it is mixed with oxygen and then admitted into the manifold 38.

FIG. 2 illustrates the hollow manifold 38 from the throttle device 80 side of the manifold. As can be seen in the drawing, the manifold 38 has an elongated configuration with two bent-elbow portions 84 and 86 which are spaced apart at a distance sufficient to align the bent portions with the engine cylinders 76 and 78. The portions 84 and 86 are open on the bottom allowing the air-fuel stream 90 injected by the injectors 20, 22 to exit the manifold 38.

FIG. 3 illustrates the manifold 38 and the throttle device 80 coupled thereto. The throttle device 80 opens into the hollow interior of the manifold 38 to deliver a stream of air 92 via an air intake conduit 94. A throttle valve 96 is positioned in the throttle device 80 to directly regulate the amount of air entering the engine 50, indirectly controlling the amount of fuel and air burned on each cycle. The throttle valve 96 can be a butterfly valve, which is housed in the throttle body. When the throttle is wide open, the intake manifold is at ambient atmospheric pressure. When the throttle is partially closed, a manifold vacuum develops as the intake drops below ambient pressure. The ECU 26 monitors position of the throttle and collects data from all sensors. The ECU 26 can finely control the fuel injectors 20, 22 in order to reduce emissions and maximize engine performance.

FIG. 4 schematically illustrates delivery of atomized fuel stream 100 into the engine 50 upstream of a cylinder intake valve 102. The fuel injector 20 is provided with an electrical terminal 104 for connection to the wire 46 and then to the ECU 26. The nozzle 106 of the injector 20 fits tightly into an opening 108 on top of the engine cylinder 76. If desired a sealing O-ring 110 can be fitted between the body of the cylinder 76 and the nozzle 106 to prevent escape of fuel from the manifold and the injector.

It is envisioned that the system 10 will be available in two ways:

1. A bolt-on kit available as a conversion on motors, which were equipped with a carburetor system during manufacturing. This will be a kit that does not require installation of a trigger wheel and crankshaft position sensor. It will tune the fuel system using sensors on the throttle position, temperature, and exhaust air ratio and will be a cleaner system than the carburetor system. It will include a practical fuel supply system that will work with available outboard motor fuel tanks. It will be a convenient aftermarket system.
2. A kit that includes all the parts that are commonly used on modern fuel injection systems. It will be tunable to make the engine meet emissions regulations and a fuel supply system that will work with available outboard motor fuel tanks that meet emissions regulations.

In operation, the low pressure fuel pump 12 supplies fuel from the fuel tank 14 to the fuel reservoir/vapor separator 16. The high pressure fuel pump 18 supplies pressurized fuel to two fuel injectors 20, 22 that protrude into the intake manifolds 76, 78 in a position that when activated release pressurized fuel directly at the opened intake valve 103 of the combustion chamber 112. This fuel is kept pressurized by the fuel pressure regulator 24. The high pressure fuel pump 18 runs constantly, keeping fuel pressure at the fuel injectors and at the fuel pressure regulator.

The engine 50 uses only a small amount of the pressurized fuel and the volume of fuel that is not used, is relieved through the fuel pressure regulator 24. The unused relieved fuel contains vapor bubbles. The unused fuel and vapor bubbles return to the reservoir/vapor separator 16. The vapor rises and exits through the tube 58 in the top of the reservoir/separator 16 and travels into the throttle body 80 where it enters the engine intake system and then the combustion chamber to be burnt during combustion. The unused returned fuel is then re-circulated by the high pressure fuel pump 18 to the fuel injectors 20, 22.

The electronic fuel injection system 10 of the instant invention can be used for smaller displacement engines such as those used on generators, riding lawnmowers, and shallow water outboard motors. This system replaces the carburetor system on such engines with a modern electronic fuel injection system.

Many changes and modifications can be made in the system of the present invention without departing from the spirit thereof. I, therefore pray that my rights to the present invention be limited only by the scope of the appended claims.

I claim:

1. A fuel injection system which supplies fuel to an internal combustion engine, comprising:
a fuel tank configured to retain a pre-determined quantity of liquid fuel;
a first pressure pump configured to pressurize and feed fuel from the fuel tank;
a vapor separator mounted between the first pressure pump and the fuel tank;
a manifold fluidly connected to the first pressure pump and aligned with an intake side of the internal combustion engine;
at least one injector carried by the manifold, said at least one injector being configured for injecting fuel and air stream into an intake of the internal combustion engine; and
an electronic control means operationally connected to the first pressure pump and the at least one injector for controlling delivery of fuel to the internal combustion engine through the at least one injector.

2. The system of claim 1, comprising a fuel pressure regulator operationally connected to the vapor separator and the at least one injector, the pressure regulator configured to maintain fuel delivered to the at least one injector at a predetermined pressure level and relieve unused fuel to the vapor separator.

3. The system of claim 1, said first pressure pump is a high-pressure pump.

4. The system of claim 3, comprising a second pressure pump mounted between the fuel tank and the vapor separator.

5. The system of claim 4, said second pressure pump is a low-pressure pump.

6. The system of claim 1, comprising a fuel filter positioned downstream of the first pressure pump.

7. The system of claim 1, comprising a throttle device coupled to the manifold and an intake air temperature sensor connected to the throttle device, said air temperature sensor being operationally connected to the electronic control means.

8. The system of claim 1, comprising a manifold absolute pressure sensor configured to detect air pressure in the manifold and transmit the detected information to the electronic control means.

9. The system of claim 1, comprising an engine temperature sensor coupled to the internal combustion engine and connected to the electronic control means.

10. The system of claim 1, said vapor separator being configured to receive unused fuel and vapor and re-circulate the unused fuel and vapor to the at least one injector.

11. A kit assembly for replacing a carburetor-based fuel delivery system of an internal combustion engine with a fuel-injection system, comprising:
a fuel tank configured to retain a pre-determined quantity of liquid fuel;
a first pressure pump configured to pressurize and feed fuel from the fuel tank;
a vapor separator configured for mounting between the first pressure pump and the fuel tank;
a second pressure pump configured for mounting upstream of the vapor separator;
a manifold configured for mounting on and in alignment with, an intake side of the internal combustion engine, said manifold being configured for connection to the first pressure pump;
at least one injector carried by the manifold, said at least one injector being configured for injecting fuel and air stream into an intake of the internal combustion engine;
a pressure regulator configured for operation connection to the vapor separator and the at least one injector; and
an electronic control means configured for operational connection to the first pressure pump and the at least one injector for controlling delivery of fuel to the internal combustion engine through the at least one injector.

12. The assembly of claim 11, said first pressure pump is a high-pressure pump.

13. The assembly of claim 12, comprising a second pressure pump configured for mounting between the fuel tank and the vapor separator.

14. The assembly of claim 13, said second pressure pump is a low-pressure pump.

15. The assembly of claim 11, comprising a fuel filter configured for positioning downstream of the first pressure pump.

16. The assembly of claim 11, comprising a throttle device coupled to the manifold and an intake air temperature sensor connected to the throttle device, said air temperature sensor being configure for operational connection to the electronic control means.

17. The assembly of claim 1, comprising a manifold absolute pressure sensor configured to detect air pressure in the manifold and transmit the detected information to the electronic control means.

18. The assembly of claim 11, comprising an engine temperature sensor coupled to the internal combustion engine and connected to the electronic control means.

19. The assembly of claim 11, said vapor separator being configured to receive unused fuel and vapor and re-circulate the unused fuel and vapor to the at least one injector.

20. A method of supplying fuel to an internal combustion engine, comprising the steps:
providing a manifold and mounting the manifold in alignment with an intake side of the internal combustion engine;
providing at least one injector extending from the manifold into an intake chamber of the internal combustion engine;
providing a throttle device configured to deliver air, through the manifold, to the at least one injector;
providing a fuel tank configured to retain a pre-determined quantity of liquid fuel;
providing a low-pressure pump fluidly connected to the fuel tank and extracting a pre-determined amount of fuel from the fuel tank at a first pressure value;
providing a vapor separator and delivering the fuel extracted from the fuel tank into the vapor separator;
providing a high-pressure pump in fluid communication with the vapor separator and pressurizing the fuel removed from the vapor separator to a second pressure value;
delivering fuel pressurized to the second pressure value to the at least one injector and atomizing the fuel prior to injecting the fuel into the intake chamber of the internal combustion engine; and
providing a control means for controlling delivery of fuel pressurized to the second pressure value through the at least one injector.

21. The method of claim 20, comprising a step of providing a pressure regulator and maintaining pressurization of fuel pressurized to the second pressure value at a predetermined level.

22. The method of claim 21, comprising a step of routing any unused fuel through the pressure regulator to the vapor separator.

23. The method of claim 22, comprising a step of re-circulating fuel from the vapor separator to the at least one fuel injector.

24. The method of claim 22, comprising a step of providing an intake air temperature sensor connected to the throttle device, said air temperature sensor being operationally connected to the electronic control means.

25. The method of claim 22, comprising a step of providing a manifold absolute pressure sensor configured to detect air pressure in the manifold and transmitting the detected information to the electronic control means.

26. The method of claim 21, comprising a step of providing an engine temperature sensor coupled to the internal combustion engine and connected to the electronic control means.
